(19) United States
(12) Patent Application Publication
(10) Pub. No.: US 2012/0154531 A1
(43) Pub. Date: Jun. 21, 2012

(54) APPARATUS AND METHOD FOR OFFERING 3D VIDEO PROCESSING, RENDERING, AND DISPLAYING

(75) Inventors: Nac Woo KIM, Gwangju (KR); Sim Kwon Yoon, Gwangju (KR); Byung Tak Lee, Gyeonggi-do (KR); Jai Sang Koh, Gwangju (KR)

(73) Assignee: ELECTRONICS AND TELECOMMUNICATIONS RESEARCH INSTITUTE, Daejeon (KR)

(21) Appl. No.: 13/326,853

(22) Filed: Dec. 15, 2011

(30) Foreign Application Priority Data
Dec. 16, 2010 (KR) 10-2010-0129520

(51) Int. Cl. H04N 13/04

(52) U.S. Cl. 348/43; 348/51; 348/E13.026; 348/E13.064

(57) ABSTRACT

Disclosed is a 3D video display device providing a first video inputted into a left eye and a second video inputted into a right eye, the 3D video display device including: a control information acquiring device receiving control information; and a 3D broadcasting receiving device controlling a binocular disparity between the first video and the second video by using the control information transferred from the control information acquiring device as a key. According to the present invention, since a 3D video is reconfigured considering a distance between the user and the 3D video display device acquired by a control information acquiring device, a user's preference, or the like, it is possible to provide the 3D video in which a user can perceive optimal depth perception.

### CROSS-REFERENCE TO RELATED APPLICATIONS

This application claims priority to and the benefit of Korean Patent Application No. 10-2010-0129520 filed in the Korean Intellectual Property Office on Dec. 16, 2010, the entire contents of which are incorporated herein by reference.

### TECHNICAL FIELD

The present invention relates to a 3D video display device and a displaying method thereof. In more particular, the present invention relates to a 3D video display device which switches 3D video displayed in the 3D video display device according to a viewing environment and a processing method thereof.

### BACKGROUND ART

Recently, as a 3D video technology and a broadcasting technology have developed rapidly, various services for a realistic 3D broadcast, which enables a user to view a realistic 3D video through a TV at a theater and even at home, have been planned.

As a method of offering the realistic 3D video to a home, there are a method of using a storing device such as a blu-ray disk capable of storing a large capacity of 3D video contents and a method of receiving the 3D video contents through a terrestrial or satellite broadcasting, or cable TV provider.

In this case, the more accurate the depth perception that a viewer perceives from the reproduced 3D video is, the more clearly the viewer may acquire sense of reality.

However, since a viewing environment of the viewer receiving the 3D contents is not uniform, there in a problem in that the depth perception of the 3D video is disordered. That is, there is a problem in that an initial-photographed 3D video cannot help being reproduced in a 3D video display device having various sizes and resolutions, such that the depth perception may not be maintained at the initial-photographed state and distortion of the screen occurs.

Further, since there is an individual difference in the depth perception that the viewers perceive and a distance between the viewer and the video display device which has influence on the depth perception of the 3D video is not uniform, there is a problem in that it is practically impossible to provide the uniform depth perception to all the viewers.

Meanwhile, in order to view 3D contents produced for use in a theater at home, the 3D video of the 3D contents for use in a theater need to be reprocessed so as to be suitable for the 3D video display device for use in a home, such that there is a problem in that enormous costs and inefficiency are caused.

### SUMMARY

The present invention has been made in an effort to provide a 3D video display device converting a 3D video displayed on the 3D video display device according to a viewing environment so that a user perceives optimal depth perception and a displaying method thereof.

An exemplary embodiment of the present invention provides a 3D video display device providing a first video inputted into a left eye and a second video inputted into a right eye, the 3D video display device including: a control information acquiring device receiving control information; and a 3D broadcasting receiving device controlling a binocular disparity between the first video and the second video by using the control information transferred from the control information acquiring device as a key.

The 3D broadcasting receiving device may include a video segmenting unit receiving raw data of a 3D video format form to segment the received raw data into the first video and the second video; an object segmenting unit segmenting a foreground object and a background object from the first video and the second video; and a video synthesizing unit controlling a binocular disparity between the foreground object and the background object corresponding to the first video and the second video by using the control information as a key.

The 3D broadcasting receiving device may further include a database storing a depth value information table for the foreground object and the background object; and an external signal processing unit retrieving the depth value matched with the control information by comparing the control information with the depth value information matching table stored in the database.

The depth values may be independently calculated between the corresponding objects and the video synthesizing unit may receive the independently calculated difference value to separately control the depth values of each object video.

The video synthesizing unit may include a depth controlling unit controlling the depth values of each object video; a color controlling unit correcting uniformly the colors of each object; and a sharpness processing unit correcting pixels and lines so that the video outputted from the color controlling unit has predetermined resolution or more.

The control information acquiring device may be at least one of an infrared camera, a webcam, or a remote controller. Further, the 3D video display device may further include a pointing means.

Another exemplary embodiment of the present invention provides a 3D video displaying method, including: a first step of receiving raw data of a 3D video format form to segment the received raw data into a first video inputted into a left eye and a second video inputted into a right eye; a second step of controlling a difference in chromaticity or grayscale between the first video and the second video within a predetermined range; a third step of segmenting a foreground object and a background object from the first video and the second video; a fourth step of calculating a depth control value of the 3D video with respect to the foreground object and the background object; and a fifth step of reconfiguring the 3D video by controlling the depth values of the videos of the foreground object and the background object according to the calculated depth control value.

The depth control value of the fourth step may be calculated by deducing a separate binocular disparity calculated from an actual distance from the user from a predetermined standard binocular disparity according to the distance from the user.

The 3D video displaying method may further include correcting pixels and lines of the reconfigured 3D video so that the reconfigured 3D video has a predetermined resolution.

According to exemplary embodiments of the present invention, since a 3D video is reconfigured by using control information acquired by a control information acquiring device, it is possible to provide the 3D video in which a user can perceive optimal depth perception.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a 3D video broadcasting system including a 3D video display device according to an exemplary embodiment of the present invention.

FIG. 2 is a configuration diagram of a 3D broadcasting receiving device according to an exemplary embodiment of the present invention.

FIG. 3 is a configuration diagram of a video synthesizing unit according to an exemplary embodiment of the present invention.

FIG. 4 is a flowchart showing a method for processing a 3D video according to an exemplary embodiment of the present invention.

FIG. 5 is a flowchart showing a method for processing a 3D video according to an exemplary embodiment of the present invention.

FIG. 6 is a schematic diagram showing object segmentation of a binocular video according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Throughout the specification, when a predetermined portion is described to be “connected to” another portion, it includes a case where the predetermined portion is electrically connected to the other portion by disposing still another predetermined portion therebetween, as well as a case where the predetermined portion is directly connected to the other portion. Also, when the predetermined portion is described to include a predetermined constituent element, it indicates that unless otherwise defined, the predetermined portion may further include another constituent element, not precluding the other constituent element.

Also, the term module described in the present specification indicates a single unit to process a predetermined function or operation and may be configured by hardware or software, or a combination of hardware and software.

Specific terms are provided to help understandings of the present invention. The use of the specific terms may be changed into other forms without departing from the technical idea of the present invention.

Hereinafter, exemplary embodiments of the present invention will be described in detail with reference to the accompanying drawings.

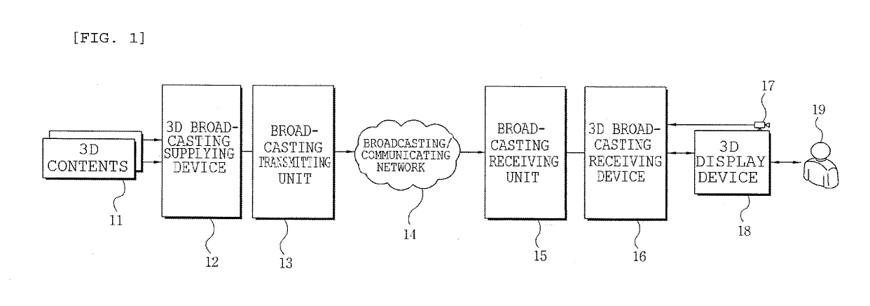

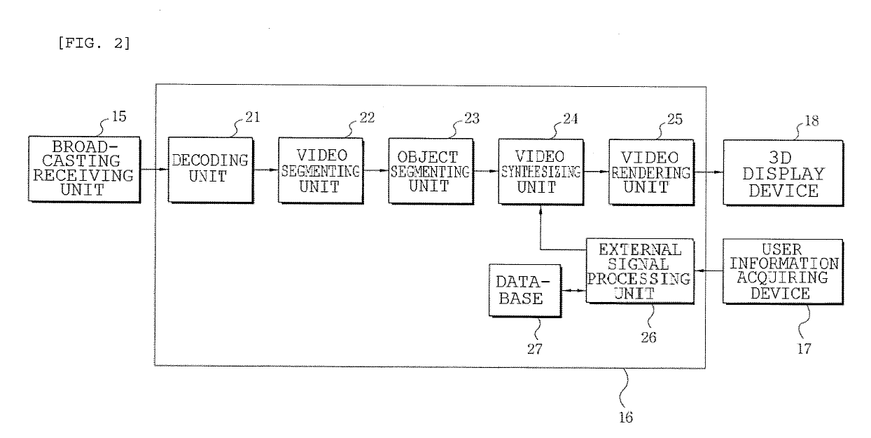

FIG. 1 is a configuration diagram of a 3D video broadcasting system including a 3D video display device according to an exemplary embodiment of the present invention. As shown in FIG. 1, the broadcasting system including the 3D video display device according to the exemplary embodiment of the present invention includes a 3D broadcasting supplying device 12, a broadcasting transmitting unit 13, a broadcasting/communicating network 14, a broadcasting receiving unit 15, and a 3D display device 18. A control information acquiring device 17 is to acquire surrounding information required to control depth perception of the 3D video according to the exemplary embodiment of the present invention and will be described in detail in the description of a 3D broadcasting receiving device 16 of FIG. 2.

Acquired 3D contents 11 are pre-processed and decoded in a form suitable for a video transmission by the 3D broadcasting supplying device 12. The decoded 3D contents are packet-multiplexed via the broadcasting transmitting unit 13 and then, transmitted through the broadcasting/communicating network 14 of a wired or wireless form. The 3D contents which are received to the broadcasting receiving unit 15 via the broadcasting/communicating network 14 are demultiplexed again. The demultiplexed 3D contents are transferred to the 3D broadcasting receiving device 16.

FIG. 2 is a configuration diagram of a 3D broadcasting receiving device 16 according to an exemplary embodiment of the present invention. The 3D broadcasting receiving device 16 is to optimize depth perception of the 3D video by reconfiguring the videos of the received 3D contents 11.

The 3D broadcasting receiving device 16 controls a disparity between a first video inputted into a left eye and a second video inputted into a right eye by using the control information transferred from the control information acquiring device 17 as a key to optimize a depth value of the 3D video.

As shown in FIG. 2, the 3D broadcasting receiving device 16 includes a decoding unit 21, a video segmenting unit 22, an object segmenting unit 23, a video synthesizing unit 24, a video rendering unit 25, an external signal processing unit 26, and a database 27.

Meanwhile, the 3D broadcasting receiving device 16 according to the exemplary embodiment of the present invention may further include a pointing means (not shown). In this case, the pointing means implies a means capable of designating a predetermined position for the displayed 3D video such as a mouse connected by wired or wireless. A method of designating the predetermined position using the pointing means will be described below in detain in a describing process of an exemplary embodiment of FIG. 6.

The decoding unit 21 is to extract raw data from the data demultiplexed in the broadcasting receiving unit 15. That is, data for signal processing inserted between the raw data for multiplexing or demultiplexing are removed from the data demultiplexed in the broadcasting receiving unit 15. Accordingly, the raw data outputted from the decoding unit 21 may have a 3D video format such as a side-by-side or a top-and-bottom in which left video data and right video data are alternately disposed or a 3D video format based on a dual mode in which each of binocular videos is separately transmitted according to a size of a 2D video.

The video segmenting unit 22 segments the binocular raw data outputted from the decoding unit 21 into 3D data. Accordingly, the 3D data outputted from the video segmenting unit 22 are segmented so as to comply with a proper 3D format such as a horizontal pattern or a vertical pattern. For example, the video segmenting unit may segment the binocular raw data into the first video inputted into the left eye and the second video inputted into the right eye.

The object segmenting unit 23 segments an object area separately from the video outputted from the video segmenting unit 22. That is, the object segmenting unit 23 segments and designates objects such as a to f and a′ to f′ with respect to a first video 42 and a second video 43 outputted from the video segmenting unit of FIG. 6. In FIG. 6, the b and d are background objects and the a, c, e, and f are foreground objects. In this case, when a binocular disparity between the corresponding objects, for example, the foreground objects a and a′ exist, a user perceives depth perception by the binocular disparity, such that the user can perceive optimal depth perception by controlling the binocular disparity.

The control degree of the binocular disparity varies according to the control information acquired by the control information acquiring device 17. That is, the control information is external input information used to control the degree of the binocular disparity, and in the 3D video display device according to the exemplary embodiment of the present invention, the optimized degree of the binocular disparity, that is, the depth perception of the 3D video is controlled by using the control information according to a user.

The control information may include user recognition information such as a user's physical characteristics acquired through a webcam, an infrared camera, or the like, distance information between the user and the 3D video, display device information such as a size of a display screen, and the like. In this case, the user may directly set the user recognition information, the distance information, the display device information, and the like as desired values by using a remote controller or the like. Hereinafter, to ease description, information on which the user directly inputs with the remote controller is called user input information.

Meanwhile, the user may preset the control information so as to be suitable for the remote controller. That is, the control information acquiring device 17 verifies whether the control information preset by using the acquired user recognition information exists and if the preset control information exists, the corresponding control information is utilized.

In this case, a distance measuring device such as the webcam or infrared camera may be configured in a settop box (STB) form or configured in a 3D TV.

The control information which is inputted through the control information acquiring device 17 such as the webcam, infrared camera, or remote controller is transferred to an external signal processing unit 26. The external signal processing unit 26 retrieves depth of the 3D video capable of perceiving optimal depth perception, that is, depth values of the foreground object and the background object described above by comparing the inputted control information with a depth value information matching table pre-stored in the database 27 and calculates depth control values by using the retrieved depth values. That is, the depth control value means a compensation value calculated by using the retrieved depth value.

Table 1 exemplifies a depth value information matching table in accordance with a user's preference and Table 2 exemplifies a depth value information matching table in accordance with a screen size of the display device. As shown Table 1 or 2, the depth value giving the optimal depth perception varies according to a viewing distance and meanwhile, and the depth value giving the optimal depth perception varies according to the user's preference although the users are positioned at the same viewing distance.

TABLE 1

| Viewing | Standard | Hong Gil | Hong Gil | Hong Gil |
|---|---|---|---|---|
| distance | depth value | Dong 1 | Dong 2 | Dong 3 |
| 1~2 m | 1 | 1 | 1.2 | 1.1 |
| 2~3 m | 2 | 2 | 2.3 | 2.2 |
| — | — | — | — | — |
| 8~10 m | 8 | 8 | 8.2 | 8.2 |
| — | — | — | — | — |

TABLE 2

| Viewing | Standard | | | |
|---|---|---|---|---|
| distance | depth value | 32 inches | 47 inches | 52 inches |
| 1~2 m | 1 | 1.32 | 1.47 | 1.52 |
| 2~3 m | 2 | 2.32 | 2.47 | 2.52 |
| — | — | — | — | — |
| 8~10 m | 8 | 8.32 | 8.47 | 8.52 |
| — | — | — | — | — |

If the distances between the 3D video and the user, that is, the viewing distances are measured by the distance measuring device, the standard depth values corresponding to the measured viewing distance are known. In the reconfiguring process of the 3D video, first, the depth value for each object is set as the standard depth value and then, the standard depth value is preferably controlled considering the personal preference or the size of the display screen. In this case, the user may control the depth value to a degree of what the user wants through the remote controller or the like.

The external signal processing unit 26 transfers the depth control value retrieved from the information matching table to the video synthesizing unit 24 and the video synthesizing unit 24 re-controls the depth value for each object by using the transferred depth control value.

FIG. 3 is a configuration diagram of a video synthesizing unit 24 according to an exemplary embodiment of the present invention. As shown in FIG. 3, the video synthesizing unit 24 includes a depth controlling unit 31, a color controlling unit 32, a sharpness processing unit 33, and a video reconfiguring unit 34. That is, the video reconfiguring unit 34 outputs the reconfigured 3D video after performing the depth control, the color control, and the sharpness processing with respect to each object.

The depth controlling unit 31 determines the depth value for each object by using the depth control value inputted from the external signal processing unit 26. In this case, the depth values for each object are independent from each other and may be controlled as different values and furthermore, the depth values for each object may also be linearly or non-linearly controlled.

The color controlling unit 32 is to uniformly correct the colors of the objects and uniformly maintain the corresponding colors of the objects.

The sharpness processing unit 33 is to correct disorder of each pixel and each line of the video finally reconfigured in the video reconfiguring unit 34 like an original image.

The 3D video reconfigured in the video reconfiguring unit 34 is displayed on the 3D display device via the video rendering unit 25.

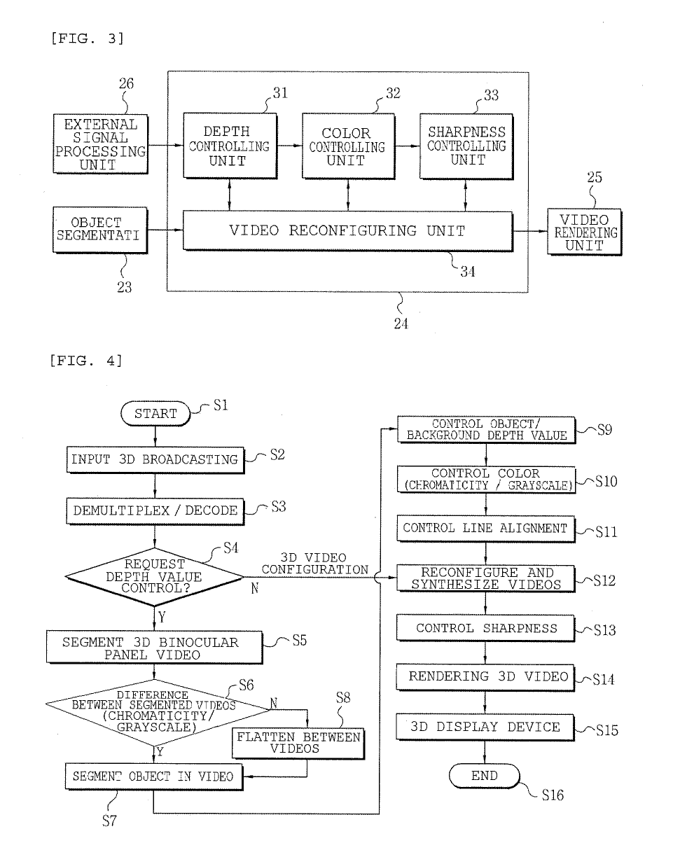

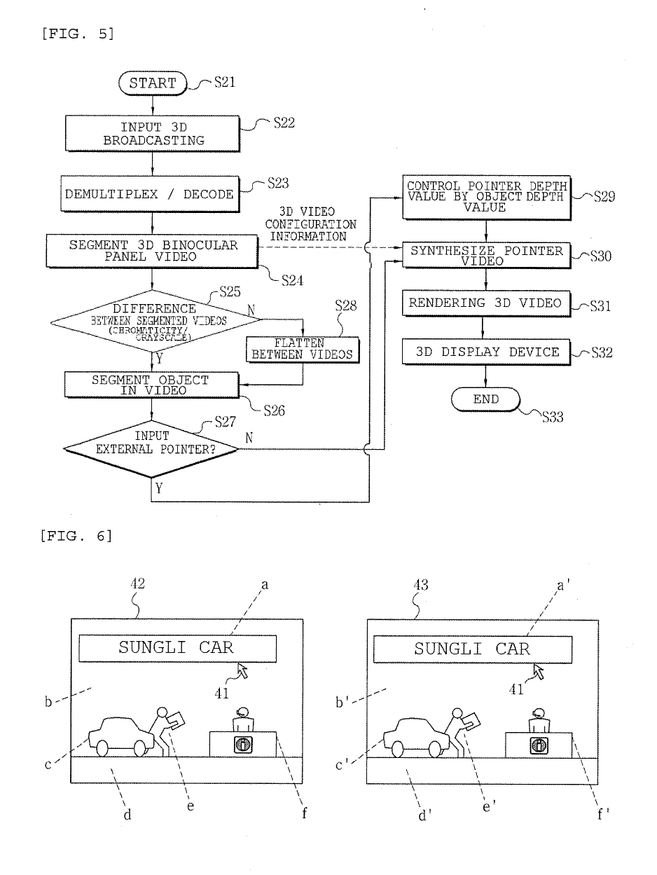

FIGS. 4 and 5 are flowcharts showing a method for processing a 3D video according to an exemplary embodiment of the present invention.

The 3D contents received through the broadcasting and communicating network 14 (S1 and S2) are demultiplexed in the broadcasting receiving unit 15 and the demultiplexed 3D contents are decoded in the 3D broadcasting receiving device 16 (S3) and as a result, raw data in a 3D video format form are generated. Thereafter, it is first determined whether depth value control is required for the raw data (S4). That is, in the case where the depth value of the 3D video determined by using the control information acquired through the control information acquiring device 17 as a key is suitable for a predetermined level, the control for the depth value is not performed. In the case where the control for the depth value is not required, the sharpness is controlled in the sharpness processing unit 33 of the video synthesizing unit 24 and then, the 3D video is reproduced by the 3D display device (S12 to S16).

However, in the case where the control for the depth value is required, the depth value is controlled by the following process.

First, the inputted raw data of the 3D video format form are segmented into a first video inputted into a left eye and a second video inputted into a right eye (S5) and a difference in chromaticity or grayscale between the segmented first video and second video is controlled within a predetermined range (S6). If the control of the chromaticity or grayscale is completed, the control for the depth value is performed according to the depth control value calculated in the external signal processing unit 26 (S9). Thereafter, since the processes reconfiguring the 3D video through the color and the line alignment (sharpness) and reproducing the 3D video through the 3D display device are the same as the reproducing process in the 3D video display device, more detailed description thereof is omitted.

In this case, the depth control value is generally calculated by deducting a separate binocular disparity calculated from the actual distance from the user from a predetermined standard binocular disparity according to the distance from the user.

FIG. 6 is a schematic diagram showing object segmentation of a binocular video according to an exemplary embodiment of the present invention. As described above, in the present invention, the depth values are separately controlled with respect to the segmented object a to f and a′ to f′.

Meanwhile, the 3D broadcasting receiving device 16 according to the exemplary embodiment of the present invention may include a pointing means (not shown) such as a mouse and in the case where the predetermined object is pointed by using the pointing means, it is preferred that a recognizer such as a mouse pointer has the same depth value as the pointed object. In this case, the mouse pointer displayed on the display screen is also recognized as one separate object, such that the mouse pointer is reproduced so as to have the same depth value as the pointed object. In addition, since a reproducing method thereof is the same as the reproducing method of the 3D video, a more detailed description on the reproducing method of the mouse pointer is omitted.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A 3D video display device providing a first video inputted into a left eye and a second video inputted into a right eye, the 3D video display device comprising:
a control information acquiring device receiving control information; and
a 3D broadcasting receiving device controlling a binocular disparity between the first video and the second video by using the control information transferred from the control information acquiring device as a key.

2. The 3D video display device of claim 1, wherein the 3D broadcasting receiving device includes:
a video segmenting unit receiving raw data of a 3D video format form to segment the received raw data into the first video and the second video;
an object segmenting unit segmenting a foreground object and a background object from the first video and the second video; and
a video synthesizing unit controlling a binocular disparity between the foreground object and the background object corresponding to the first video and the second video by using the control information as a key.

3. The 3D video display device of claim 2, wherein the 3D broadcasting receiving device further includes:
a database storing a depth value information table for the foreground object and the background object; and
an external signal processing unit retrieving the depth value matched with the control information by comparing the control information with the depth value information matching table stored in the database.

4. The 3D video display device of claim 3, wherein the depth values are independently calculated between the corresponding objects and the video synthesizing unit receives the independently calculated difference value to separately control the depth values of each object video.

5. The 3D video display device of claim 4, wherein the video synthesizing unit includes:
a depth controlling unit controlling the depth values of each object video;
a color controlling unit uniformly correcting the colors of each object; and
an sharpness processing unit correcting pixels and lines so that the video outputted from the color controlling unit has a predetermined resolution or more.

6. The 3D video display device of claim 1, wherein the control information acquiring device is at least one of an infrared camera, a webcam, or a remote controller.

7. The 3D video display device of claim 1, further comprising a pointing means.

8. A 3D video displaying method, comprising:
a first step of receiving raw data of a 3D video format form to segment the received raw data into a first video inputted into a left eye and a second video inputted into a right eye;
a second step of controlling a difference in chromaticity or grayscale between the first video and the second video within a predetermined range;
a third step of segmenting a foreground object and a background object from the first video and the second video;
a fourth step of calculating a depth control value of the 3D video with respect to the foreground object and the background object; and
a fifth step of reconfiguring the 3D video by controlling the depth values of the videos of the foreground object and the background object according to the calculated depth control value.

9. The method of claim 8, wherein the depth control value of the fourth step is calculated by deducing a separate binocular disparity calculated from an actual distance from the user from a predetermined standard binocular disparity according to the distance from the user.

10. The method of claim 8, further comprising correcting pixels and lines of the reconfigured 3D video so that the reconfigured 3D video has a predetermined resolution.
